(19) United States
(12) Patent Application Publication
(10) Pub. No.: US 2020/0056765 A1
(43) Pub. Date: Feb. 20, 2020

(54) MULTI-FUNCTION ACTIVE ACCESSORIES FOR LED LAMPS

(71) Applicant: Soraa, Inc., Fremont, CA (US)

(72) Inventors: LASZLO TAKACS, FREMONT, CA (US); WILFRED A. MARTIS, SAN FRANCISCO, CA (US); FRANK SHUM, SUNNYVALE, CA (US); ARTEM MISHIN, PACIFICA, CA (US); VINOD KHOSLA, FREMONT, CA (US); RADHA NAYAK, FREMONT, CA (US); MICHAEL RAGAN KRAMES, MOUNTAIN VIEW, CA (US)

(21) Appl. No.: 16/550,996

(22) Filed: Aug. 26, 2019

Related U.S. Application Data
(63) Continuation of application No. 14/543,164, filed on Nov. 17, 2014, now Pat. No. 10,436,422.
Application No. 14/543,164 is a continuation-in-part of application No. 14/336,276, filed on Jul. 21, 2014, now Pat. No. 9,995,439.
Application No. 14/336,276 is a continuation-in-part of application No. 13/894,203, filed on May 14, 2013, now Pat. No. 9,360,190.
Application No. 13/894,203 is a continuation-in-part of application No. 13/865,760, filed on Apr. 18, 2013, now Pat. No. 9,310,052.
Application No. 14/336,276 is a continuation-in-part of application No. 13/909,752, filed on Jun. 4, 2013, now Pat. No. 8,888,332.
Application No. 14/336,276 is a continuation-in-part of application No. 14/014,112, filed on Aug. 29, 2013, now Pat. No. 9,109,760.
Application No. 14/014,112 is a continuation-in-part of application No. 13/915,432, filed on Jun. 11, 2013, now abandoned.
(60) Provisional application No. 61/707,757, filed on Sep. 28, 2012.
(60) Provisional application No. 61/646,766, filed on May 14, 2012.
(60) Provisional application No. 61/776,173, filed on Mar. 11, 2013.
(60) Provisional application No. 61/655,894, filed on Jun. 5, 2012.
(60) Provisional application No. 61/659,386, filed on Jun. 13, 2012.

(51) Int. Cl. F21V 17/10; F21V 5/04; F21V 17/00

(52) U.S. Cl. CPC F21V 17/105; F21V 17/002; F21V 5/04

(57) ABSTRACT

Apparatus and methods of attaching accessories to LED lamps and for providing active accessories in LED lamps are disclosed. The active accessories include single-function active accessories as well as multi-function active accessories.

This application is a continuation of U.S. application Ser. No. 14/543,164, filed Nov. 17, 2014, which is a continuation-in-part of U.S. application Ser. No. 14/336,276, filed on Jul. 21, 2014, which is incorporated by reference in its entirety. U.S. application Ser. No. 14/336,276 is a continuation-in-part of U.S. application Ser. No. 13/894,203 filed on May 14, 2013, which is a continuation-in-part of U.S. application Ser. No. 13/865,760 filed on Apr. 18, 2013, which claims benefit under 35 U.S.C. § 119(e) to U.S. Provisional Application No. 61/707,757 filed on Sep. 28, 2012, and U.S. application Ser. No. 13/894,203 claims the benefit under 35 U.S.C. § 119(e) to U.S. Provisional Application No. 61/646,766 filed on May 14, 2012; and U.S. application Ser. No. 14/336,276 is a continuation-in-part of U.S. application Ser. No. 13/909,752 filed on Jun. 4, 2013, which claims benefit under 35 U.S.C. § 119(e) to U.S. Provisional Application No. 61/776,173 filed on Mar. 11, 2013, and to U.S. Provisional Application No. 61/655,894 filed on Jun. 5, 2012; and U.S. application Ser. No. 14/336,276 is a continuation-in-part of U.S. application Ser. No. 14/014,112 filed on Aug. 29, 2013, which is a continuation-in-part of U.S. application Ser. No. 13/915,432 filed on Jun. 11, 2013, which claims benefit under 35 U.S.C. § 119(e) to U.S. Application No. 61/659,386 filed on Jun. 13, 2012, each of which is incorporated by reference in its entirety.

### FIELD

The disclosure relates to the field of LED illumination and more particularly to techniques for making and using active accessories for LED lamps.

### BACKGROUND

Accessories for standard halogen lamps such as MR16 lamps include, for example, diffusers, color filters, polarizers, linear dispersion, and baffles. Such accessories are commercially available from companies such as Abrisa, Rosco, and Lee Filters. These accessories can be used to control the quality of light including elimination of glare, to change the color temperature of the lamp, or to tailor a beam profile for a particular application.

Generally, accessories for halogen lamps are required to withstand high temperature and may be made of glass, and often require special mechanical holders or fixtures to incorporate with the halogen lamp. Often, such halogen lamp accessories require disassembly of the lamp from the fixture to incorporate the accessory into the fixture. This set of disadvantages results in the accessories having high costs and being cumbersome to install.

At the same time, miniaturized electronics have become very small and relatively inexpensive, thus providing an opportunity to deploy miniaturized electronics adapted as active accessories in conjunction with LED lamps.

Therefore, there is a need for improved approaches for configuring selections of one or more active and/or passive accessories to mate with LED lamps.

### SUMMARY

This disclosure relates to apparatus allowing for simple and low cost implementation of accessories for LED lamps that can be used to retrofit existing fixtures. In other words, the accessories disclosed herein are compatible with fixtures that may not have been designed to be used with such accessories. In certain embodiments, disassembly of LED lamps is not necessary for installation of the accessories.

Many of the embodiments herein address use of an active electronic component that is integrated into or used with an LED lamp. Some implement electronic circuitry in a base, and some implement electronic circuitry (including connectivity) in a “smart” adapter. Examples of such embodiments are included in the appended figures and in the description.

### BRIEF DESCRIPTION OF THE DRAWINGS

Those skilled in the art will understand that the drawings, described herein, are for illustration purposes only. The drawings are not intended to limit the scope of the present disclosure. This patent or application file contains at least one drawing executed in color. Copies of this patent or patent application publication with color drawings will be provided by the U.S. Patent and Trademark Office upon request and payment of the necessary fee.

FIG. 1 shows a housing for implementing active accessories in an LED lamp, according to some embodiments.

FIG. 2 shows an adapter used to provide active accessories in an LED lamp, according to some embodiments.

FIG. 3 shows superimposed profile shapes found in a range of lamp standards adapted to be used for providing active accessories in an LED lamp, according to some embodiments.

FIG. 4 shows an exploded view of an assembly found in a range of lamp standards adapted to be used for providing active accessories in an LED lamp, according to some embodiments.

FIG. 5 shows a top view of a hybrid connector adapted to be used for providing active accessories in an LED lamp, according to some embodiments.

FIG. 6 shows a side view of a hybrid connector adapted to be used as a USB slave device for providing active accessories in an LED lamp, according to some embodiments.

FIG. 7 shows a side view of a hybrid connector adapted to be used as a USB master device for providing active accessories in an LED lamp, according to some embodiments.

FIG. 8 shows a side view of a hybrid connector adapted to be used as power-delivery device for providing active accessories in an LED lamp, according to some embodiments.

FIG. 9 shows an exploded view of an assembly found in a range of lamp standards adapted to be used for providing active accessories in an LED lamp, according to some embodiments.

FIG. 10A depicts an assembled LED lamp with an accessory according to some embodiments.

FIG. 10B shows an exploded view of an LED lamp with an accessory according to some embodiments.

FIG. 11 shows an exploded view of an LED lamp with multiple accessories, according to some embodiments.

FIG. 12 depicts an environment within which LED lamps with multiple active accessories can be deployed.

FIG. 13 depicts a selection of views of a lamp having an attachment about the periphery of the lamp face as used for hosting active accessories, according to one embodiment.

FIG. 14 depicts a selection of views of a PAR lamp having an attachment about the periphery of a PAR lamp face as used for hosting active accessories, according to one embodiment.

FIG. 15 depicts a selection of views of an MR-16 lamp having an auto-centering attachment positioned about the periphery of an MR-16 lamp face as used for hosting active accessories, according to one embodiment.

FIG. 16 depicts a selection of views of an PAR lamp having periphery attachment points positioned about the periphery of a PAR lamp face as used for hosting active accessories, according to one embodiment.

FIG. 17 depicts a selection of views of an MR-16 lamp having keyed attachment points positioned about the periphery of an MR-16 lamp face as used for hosting active accessories, according to one embodiment.

FIG. 18 depicts a selection of views of a PAR lamp having keyed attachment points positioned about the periphery of a PAR lamp face as used for hosting active accessories, according to one embodiment.

FIG. 19 depicts a selection of views of a PAR lamp having color-coded keyed attachment points positioned about the periphery of a PAR lamp face as used for hosting active accessories, according to one embodiment.

FIG. 20 depicts a selection of views of an MR-16 lamp having zone ID glare blocker for use on a lamp face as used with active accessories, according to one embodiment.

FIG. 21 depicts a selection of views of a PAR lamp having zone ID glare blockers for positioning on a lamp face as used with active accessories, according to one embodiment.

FIG. 22 depicts a side side-view cutaway to show use of two or more magnets to form an electrical contact, according to one embodiment.

### DETAILED DESCRIPTION

The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

The term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. In addition, the articles “a” and “an” as used in this application and the appended claims should generally be construed to mean “one or more” unless specified otherwise or is clear from the context to be directed to a singular form.

“Accessory” or “accessories” includes any mechanical or electro-mechanical component or electrical component or fixture to be mated to a lamp. In certain embodiments, an accessory comprises a thin, optically transparent film, sheet, or plate.

Reference is now made in detail to certain embodiments. The disclosed embodiments are not intended to be limiting of the claims.

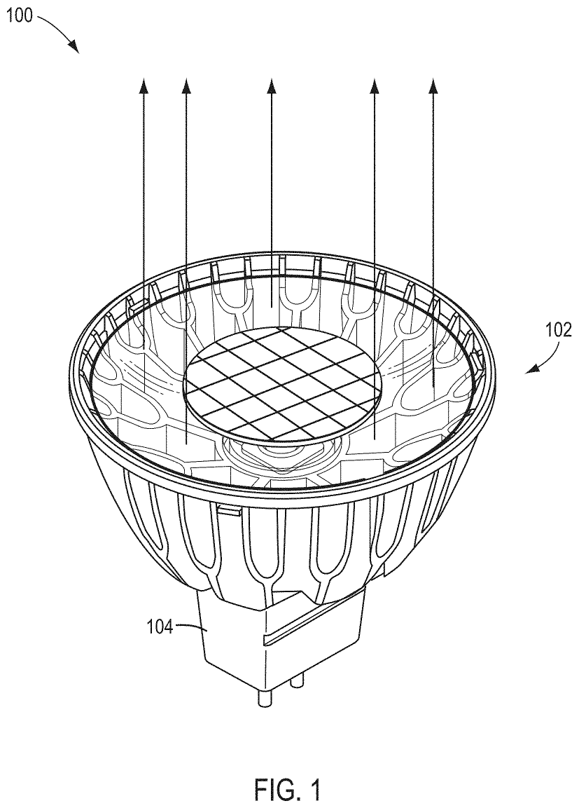

FIG. 1 shows a housing 100 for implementing active accessories in an LED lamp. The LED lamp includes a heat sink 102 and a base 104 and light (arrows) emanating from the optic.

In some embodiments, the housing has an inner volume (center cross-hatched area) suited for situating electronic components such as power conditioning circuitry and/or microprocessors and sensors.

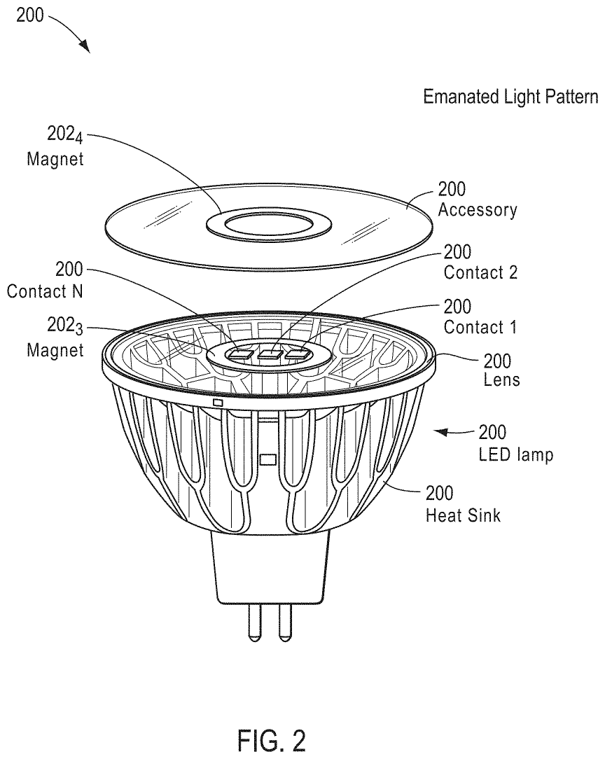

FIG. 2 shows an adapter 200 used to provide active accessories in an LED lamp. The LED lamp includes a heat sink, lens, magnet 2023, magnet 2024, an accessory, and electrical contacts N 200 (contact N, contact 1 and contact 2).

A plurality of contacts can be positioned atop the lens, and the contacts can be configured to provide an electrical connection to electronic components such as power conditioning circuitry and/or microprocessors and sensors. In some embodiments, an adapter uses magnetic forces to hold an accessory in place.

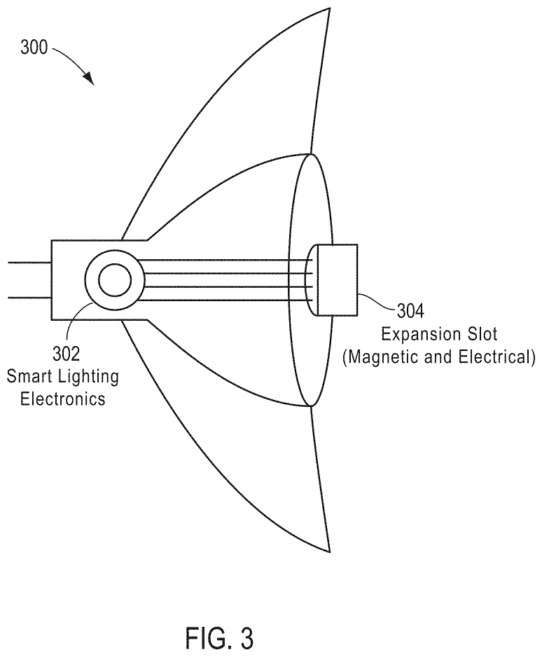

FIG. 3 shows superimposed profile shapes 300 found in a range of lamp standards adapted to be used for providing active accessories in an LED lamp. FIG. 3 also shows smart light electronics 302 electrically connected to an adapter within expansion slot 304.

A home or business may have several lamp types installed. Creating a set of smart accessories that fit any/all of these lamp types, and communicate with each other and with a central computer, in a consistent manner enables the consumer or business owner to monitor and control their environment efficiently and effectively. The accessories can have unique identifications and communicate with each other and a central computer using standard protocols such as uPnP, DLNA, or other interoperable or interoperability protocols. By using an expandable approach (e.g., using smart buttons versus a pre-integrated one that has the smarts built into each lamp) allows the lamps to be integrated into any operational environment of building management systems or smart lighting systems using a choice of smart buttons, and without having to replace the lamps.

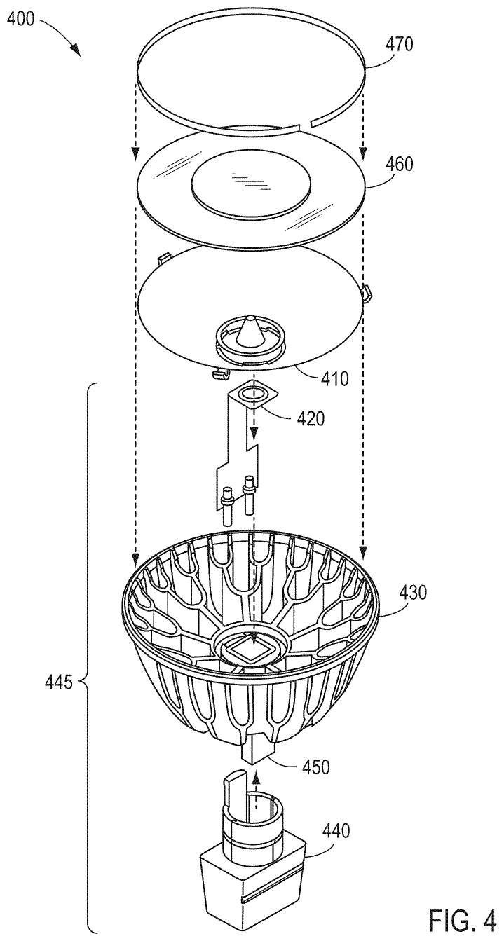

FIG. 4 show san exploded view of an assembly 400 found in a range of lamp standards adapted to be used for providing active accessories in an LED lamp. The LED lamp includes a base 440, a plug 450, a heat sink 430, a circuit including the LED 420, retaining ring 410, optic 460, and retaining ring 470.

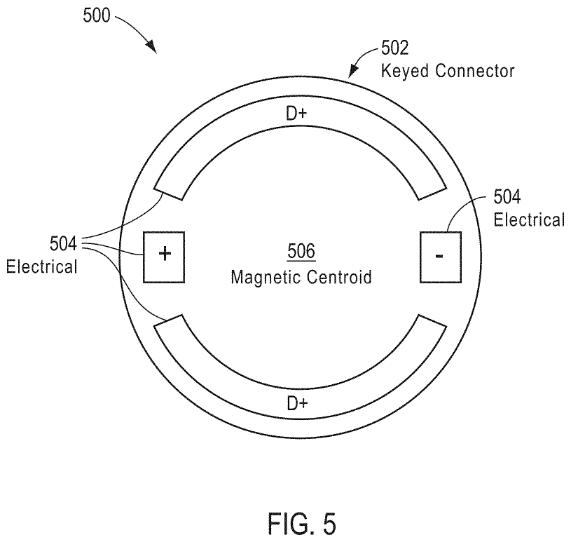

FIG. 5 shows a top view of a hybrid connector 500 adapted to be used for providing active accessories in an LED lamp. The adaptor includes electrical contacts 504, a keyed connector 502, and a magnetic centroid 506.

A standard interface like USB can be implemented using a simple connector with 4 or 5 terminals that carry power and data. USB provides the opportunity to leverage the vast ecosystem of systems and devices that have been built for the past few decades for PCs, CE devices, smartphones, etc., as well as the continuous evolution of the interface to accommodate new usages for consumers and businesses.

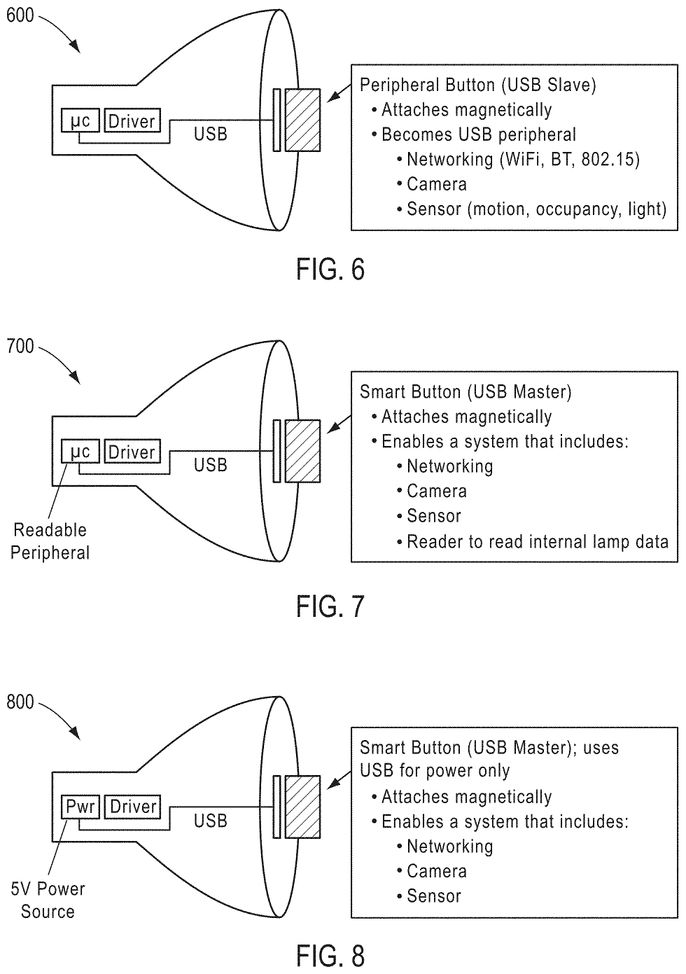

FIG. 6 shows a side view of a hybrid connector 600 adapted to be used as a USB slave device for providing active accessories in an LED lamp.

A lamp can be built with a standard microcontroller or microprocessor with associated software, and with or without persistent connectivity to other devices or a central computer. The microcontroller or microprocessor can be used for internal lamp functions like controlling the LED driver, storing operational data like hours of usage, current and temperature data, etc. By attaching a smart USB Slave button, the functionality of the lamp can be extended to include wireless communication to other lamps and a central computer for lamp monitoring and control, connection to peripheral devices like a camera and sensors.

FIG. 7 shows a side view of a hybrid connector 700 adapted to be used as a USB master device for providing active accessories in an LED lamp.

A lamp can be built with even without a microcontroller or microprocessor, yet supporting a simple USB-based readable storage that stores operational data of the lamp like hours of usage, current and temperature data, etc. Once a smart USB Master button that has a microcontroller or microprocessor is connected to the lamp, that USB device can be read by the microcontroller or microprocessor on the smart button. The smart button can also integrate wireless networking to implement lamp monitoring and control, and can communicate with other lamps and/or can communicate with a central computer. It may also contain a camera and/or other sensors.

FIG. 8 shows a side view of a hybrid connector 800 adapted to be used as power-delivery device for providing active accessories in an LED lamp.

A lamp can be built with a device that provides power to the smart button connector. When a smart USB Master button that has a microcontroller or microprocessor is connected to the lamp, the lamp can be turned into a smart lamp. The smart button can integrate wireless networking to implement lamp monitoring and control, and communication with other lamps and a central computer. It may also contain a camera and sensors. It may also contain readable storage that stores operational data of the lamp such as hours of usage, current and temperature data, etc.

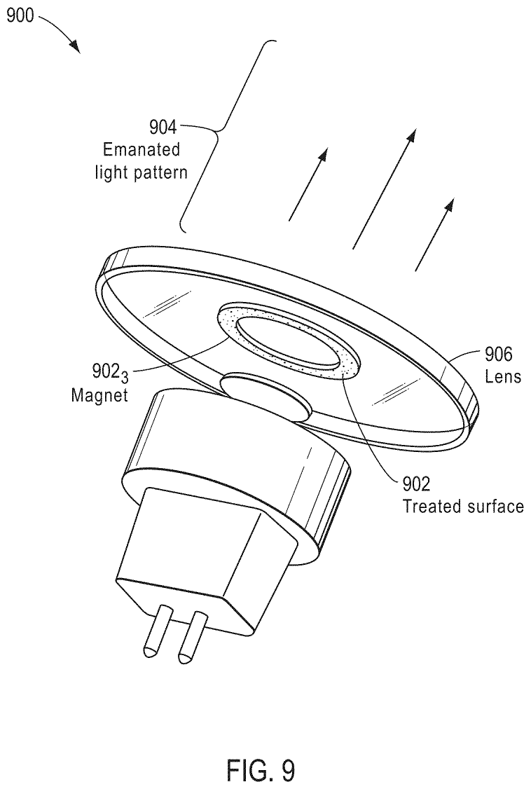

FIG. 9 shows an exploded view of an assembly 900 found in a range of lamp standards adapted to be used for providing active accessories in an LED lamp. The LED lamp includes a magnet 9023, having a treated surface 902, a lens, and an emanated light pattern 904.

One embodiment disposes accessories on the face of the lamp, in a proximity that is thermally isolated from the heat source and high temperatures of the LED. In certain embodiments, the face of the lamp is open to the environment so as to facilitate heat dissipation of any electronics. Such a face-mounting further facilitates antenna placement (e.g., for wireless operation), and for camera and sensor operation. It also makes it easy to connect and disconnect accessories.

In certain embodiments, an LED lamp comprises a lens having a center and a diameter; a first magnet attached to the center of the lens; a first accessory disposed on the lens; and a second magnet attached to the center of the first accessory; wherein the first magnet and the second magnet are configured to retain the first accessory against the lens.

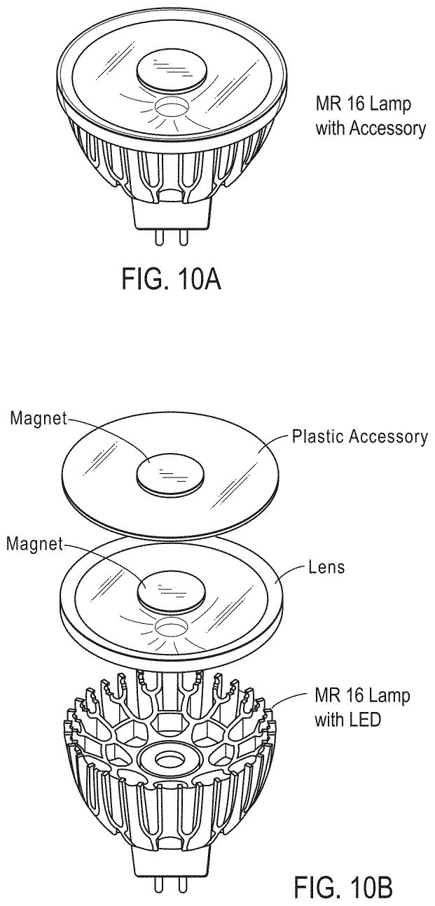

FIG. 10A depicts an LED lamp with an accessory as an exemplary system having improved accessories for LED lamps.

FIG. 10B shows an exploded view of an LED lamp with an accessory in a system having improved accessories for LED lamps.

FIGS. 10A and 10B show an example of an LED lamp having an MR16 form factor including a heat sink. A lens is attached to the heat sink or other part of the lamp. In certain embodiments, the lens comprises a folded total internal reflection lens. Attachment may be mechanically such as using prongs as shown in FIGS. 10A and 10B. A magnet is attached to the center of the lens. An accessory having a magnet attached to the center can be disposed over the lens and the opposing magnets can hold the accessory to the lens. The first and second opposing magnets can be configured to retain the accessory against the perimeter of the lens. For example, the opposing magnets may have the opposite polarity. The accessory may have substantially the same diameter as the lens, and in certain embodiments covers an optical region of the lens, such as for example greater than 90% of the optical aperture of the LED lamp. In certain embodiments, the accessory comprises a transparent film such as for example a plastic film. In certain embodiments, the accessory is selected from a diffuser, a color filter, a polarizer, a linear dispersion element, a baffle, and a combination of any of the foregoing. In certain embodiments, the first magnet and the first accessory have a combined thickness less than about 3 mm, less than about 2 mm, less than about 1 mm, less than about 0.5 mm, and in certain embodiments, less than about 0.25 mm.

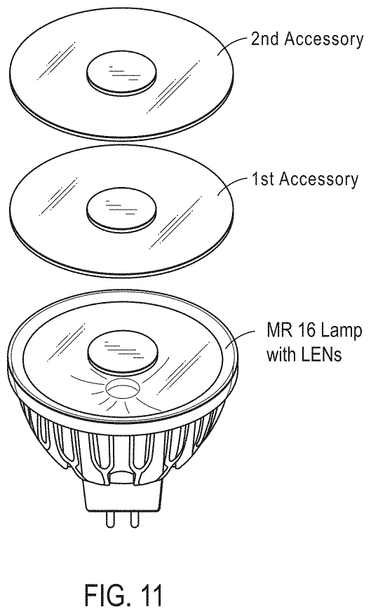

FIG. 11 shows an exploded view 1100 of an LED lamp with multiple accessories in a system having improved accessories for LED lamps.

In certain embodiments as shown in FIG. 11, an LED lamp comprises a second accessory disposed adjacent a first accessory. In certain embodiments, a second magnet is attached to the center of the second accessory and is used to affix the second accessory to the lamp. In certain embodiments wherein the lamp comprises a second accessory, a magnet is not attached to the center of the first accessory.

There are many configurations of LED lamps beyond the depicted MR-16 lamp. For example, Table 1 gives standards (see “Designation”) and corresponding characteristics.

TABLE 1

| | Base | | |
|---|---|---|---|
| | Diameter | | IEC 60061-1 |
| Desig- | (crest of | | Standard |
| nation | thread) | Name | Sheet |
| | 5 mm | Lilliput Edison Screw (LES) | 7004-25 |
| E10 | 10 mm | Miniature Edison Screw (MES) | 7004-22 |
| E11 | 11 mm | Mini-Candelabra Edison Screw | (7004-6-1) |
| | | (mini-can) | |
| E12 | 12 mm | Candelabra Edison Screw (CES) | 7004-28 |
| E14 | 14 mm | Small Edison Screw (SES) | 7004-23 |
| E17 | 17 mm | Intermediate Edison Screw (IES) | 7004-26 |
| E26 | 26 mm | [Medium] (one-inch) Edison Screw | 7004-21A-2 |
| | | (ES or MES) | |
| E27 | 27 mm | [Medium] Edison Screw (ES) | 7004-21 |
| E29 | 29 mm | [Admedium] Edison Screw (ES) | |
| E39 | 39 mm | Single-contact (Mogul) Giant Edison | 7004-24-A1 |
| | | Screw (GES) | |
| E40 | 40 mm | (Mogul) Giant Edison Screw (GES) | 7004-24 |

Additionally, a base member (e.g., shell, casing, etc.) can be of any form factor configured to support electrical connections, which electrical connections can conform to any of a set of types or standards. For example, Table 2 gives standards (see “Type”) and corresponding characteristics, including mechanical spacings.

TABLE 2

| | | Pin (center | | | | |
|---|---|---|---|---|---|---|
| Type | Standard | to center) | | Pin Diameter | | Usage |
| G4 | IEC 60061-1 | 4.0 | mm | 0.65-0.75 | mm | MR11 and other small halogens of |
| | (7004-72) | | | | | 5/10/20 watt and 6/12 volt |
| GU4 | IEC 60061-1 | 4.0 | mm | 0.95-1.05 | mm | |
| | (7004-108) | | | | | |
| GY4 | IEC 60061-1 | 4.0 | mm | 0.65-0.75 | mm | |
| | (7004-72A) | | | | | |
| GZ4 | IEC 60061-1 | 4.0 | mm | 0.95-1.05 | mm | |
| | (7004-64) | | | | | |
| G5 | IEC 60061-1 | 5 | mm | | | T4 and T5 fluorescent tubes |
| | (7004-52-5) | | | | | |
| G5.3 | IEC 60061-1 | 5.33 | mm | 1.47-1.65 | mm | |
| | (7004-73) | | | | | |
| G5.3-4.8 | IEC 60061-1 | | | | | |
| | (7004-126-1) | | | | | |
| GU5.3 | IEC 60061-1 | 5.33 | mm | 1.45-1.6 | mm | |
| | (7004-109) | | | | | |
| GX5.3 | IEC 60061-1 | 5.33 | mm | 1.45-1.6 | mm | MR16 and other small halogens of |
| | (7004-73A) | | | | | 20/35/50 watt and 12/24 volt |
| GY5.3 | IEC 60061-1 | 5.33 | mm | | | |
| | (7004-73B) | | | | | |
| G6.35 | IEC 60061-1 | 6.35 | mm | 0.95-1.05 | mm | |
| | (7004-59) | | | | | |
| GX6.35 | IEC 60061-1 | 6.35 | mm | 0.95-1.05 | mm | |
| | (7004-59) | | | | | |
| GY6.35 | IEC 60061-1 | 6.35 | mm | 1.2-1.3 | mm | Halogen 100 W 120 V |
| | (7004-59) | | | | | |
| GZ6.35 | IEC 60061-1 | 6.35 | mm | 0.95-1.05 | mm | |
| | (7004-59A) | | | | | |
| G8 | | 8.0 | mm | | | Halogen 100 W 120 V |
| GY8.6 | | 8.6 | mm | | | Halogen 100 W 120 V |
| G9 | IEC 60061-1 | 9.0 | mm | | | Halogen 120 V (US)/230 V (EU) |
| | (7004-129) | | | | | |
| G9.5 | | 9.5 | mm | 3.10-3.25 | mm | Common for theatre use, several |
| | | | | | | variants |
| GU10 | | 10 | mm | | | Twist-lock 120/230-volt MR16 |
| | | | | | | halogen lighting of 35/50 watt, |
| | | | | | | since mid-2000s |
| G12 | | 12.0 | mm | 2.35 | mm | Used in theatre and single-end |
| | | | | | | metal halide lamps |
| G13 | | 12.7 | mm | | | T8 and T12 fluorescent tubes |
| G23 | | 23 | mm | 2 | mm | |
| GU24 | | 24 | mm | | | Twist-lock for self-ballasted |
| | | | | | | compact fluorescents, since 2000s |
| G38 | | 38 | mm | | | Mostly used for high-wattage |
| | | | | | | theatre lamps |
| GX53 | | 53 | mm | | | Twist-lock for puck-shaped under- |
| | | | | | | cabinet compact fluorescents, |
| | | | | | | since 2000s |

Additionally, a lens may comprise a bulb or remote member used in forming the LED lamp. The aspect of a center can mean a center from the perspective of any center, or even a centroid (from any view) as in the case of an irregularly shaped lens.

Accessories and methods of attached accessories disclosed herein may be used with any suitable LED lamp configuration including without limitation any of those disclosed in Table 1 and/or in combination with any form factors disclosed in Table 2.

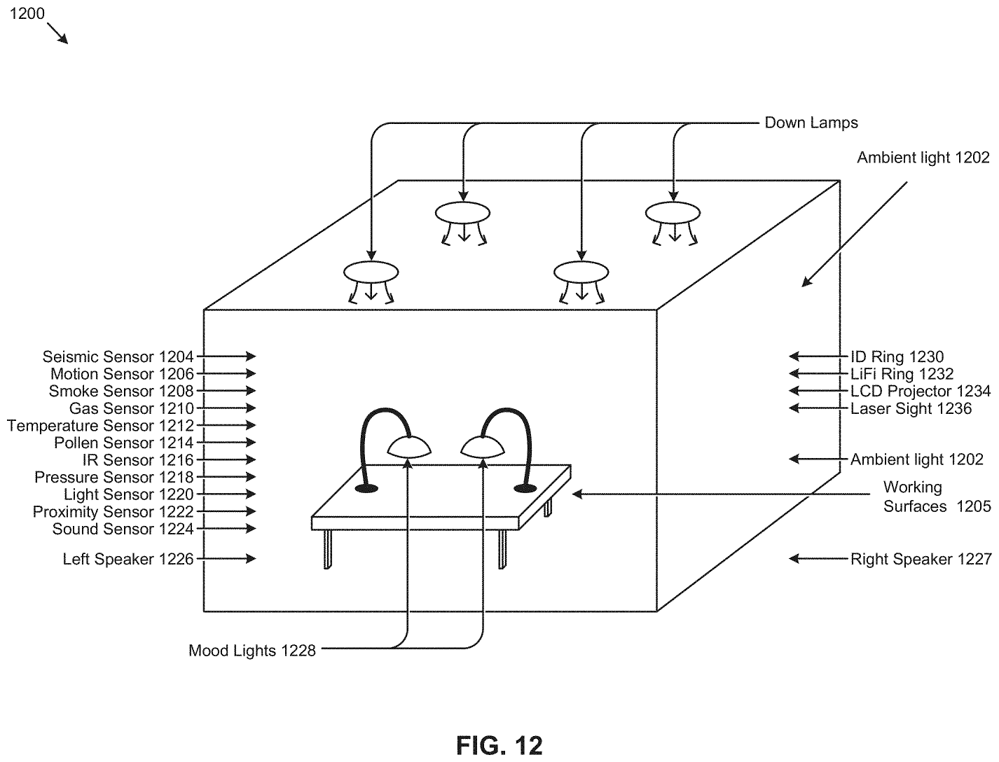

FIG. 12 depicts an environment 1200 within which LED lamps with multiple active accessories can be deployed. In particular, FIG. 12 depicts an arrangement of various lights (e.g., lamps and or fixtures) positioned in a way as to provide useful illumination both for general illumination lamps (e.g., down lamps) as well as lamps for task lighting at working surfaces 1205. There may be incidental sources of light (e.g., ambient light 1202), for example, natural light or other illumination entering the environment through a window or door.

The various lights may be grouped together in a way that is commonly known as a zone. In a lighting zone, the lamps within a group act together in their potentially variable light output. One or more of the lights may have active electronic accessories attached (“SNAPs”) which provide one or more various functionalities. In some situations, one or more or all of the lamps may be in communication with one or more of other lamps, and/or in communication with a controlling and/or monitoring device and/or the Internet (e.g., via a cloud-based control/monitor). One or more or all of the lamps may also have sensors to assess ambient light, motion, occupancy, temperature, IR data, proximity, gasses (e.g., CO, CO₂, methane, etc.), products of combustion (e.g., from fire or smoldering), smoke (e.g., cigarette smoke, compound-laden vapors, etc.), humidity, human body temperature, remote object temperature (e.g., by IR sensing) etc.

Any number of these sensors may be constructed into a SNAP form factor, and any number can be attached in any combination to one or more lamps. There may be one or more sensors (with or without wireless communication functionality) on a SNAP accessory, and there may be one or more SNAPs attached to a single lamp.

In one embodiment, a particular lamp (perhaps near a door) has a motion sensor SNAP attached. Another lamp (perhaps near a window) has an ambient light sensor. Certain lamps and/or attached SNAP accessories may have a wireless or IR communication function, and individual ones or groups of lamps can be individually or in groups as pertaining to one or more zones. Zone marking SNAPs are further discussed infra. Zone marking SNAPs may or may not be permanently affixed. In some cases a remembered zone designation may be “imparted” from an accessory to a lamp and henceforth remembered by the lamp. The impartation can occur merely through momentarily attaching a zone marking SNAP to the lamp. In such scenarios, similarly-zoned lamp can operate and/or cooperate in a group. For example, a light having a motion sensor can cause all lamps sharing the same zone designation to become activated when motion is detected. Concurrently, perhaps in the same zone or part of the zone, or in a different zone, a communication unit and/or ambient light sensor will cause certain lamps near a window to dim when incoming ambient light is sensed.

Manual control over each lamp or group of lamps can be managed under wireless control and/or under IR control, with or without intervention by an occupant of the room, or with or without intervention by an automated controller, or with or without intervention or by a remote controller located remotely from the subject lamp or group of lamps. The SNAP accessories may be freely re-deployed (e.g., to a different lamp or to a different location) and the re-deployment enables new functions corresponding to the new arrangement.

Programmed functionality may be offered by the combination of an automated controller and additional SNAPs or by the SNAPs themselves. A “Fire Egress” SNAP could designate a lamp to be always on even if dimmed 24 hours a day. An event trigger such as a detected open flame, smoke or an external signal of a fire alarm (e.g., perhaps coming through the programmed controller) being tripped can cause the lights to come to a preset maximum intensity, and/or with egress indications (e.g., illuminated arrows and/or blinking to attract attention).

Some combinations include various forms of an “Enterprise Outlook” SNAP so that an email address can become the address of a lighting system (e.g., group of lamps, similarly-zoned lamps, etc.) can become the address of a specific lamp. Strictly as one example, sending an email to lamp-on.name@domain.com might control the task light at Name's desk.

Further active elements and sample functions are given in the following tables.

TABLE 3
Sample active elements and functions.

| Active Element | Exemplary Function |
|---|---|
| “ID Ring”: | Ring fitted to lap has a “zone ID” |
| Motion detector (e.g., motion sensor 1206) | Sense and report |
| Fire Egress | Always illuminated to show the egress. |
| | Flashing or blinking during periods of |
| | alert. |
| Smoke detector (e.g., smoke sensor 1208) | Sense and report |
| Carbon-monoxide detector (e.g., gas sensor | Sense and report |
| 1210) | |
| Ambient temperature sensors (e.g., | Sense and report |
| temperature sensor 1212) | |
| Ambient sound microphone | Sense and report |
| Hi-Fi speakers | |
| Pollution detector (e.g., pollen sensor 1214) | Sense and report |
| Infrared sensor (e.g., IR sensor 1216) | Sense code and report |
| Weather detector (e.g., using pressure | Sense using barometer, temperature, |
| sensor 1218) | thunder storms, etc. |
| Ambient light detector | Vary the color gamut while keeping the |
| | chromaticity fixed. |
| Diagnostic attachment | Perform lumen readings and color readings |
| | for lifetime maintenance |
| Proximity detector (e.g. proximity sensor | Sense and report |
| 1222) | |
| Maintenance sensor LLF = 1 | (constant illumination characteristics over |
| | degradation due to time or environment) |
| Combination: Zone ring, plus motion sensor | Sense and report by zone |
| Directional sound detector (e.g., sound | Use 2 radios (e.g., Bluetooth Low-energy) |
| sensor 1224) | |
| Passive light guides of various types | To shape beams and/or to direct |
| | illumination |
| SNAP location or ID accessory | To aid in indoor positioning |
| Adjust light (auto- ON/Off) | On, Off, Dimming |
| LCD accessory | Direct beam through it to change color or |
| | focus |
| Multiple rings fit together | To and pass power and control signals |
| Laser (e.g., laser sight 1236) | Sight, other detection from laser |
| LiFi (e.g., LiFi ring 1232) | Re-broadcasting |
| Auto-commissioning ring | (e.g., based on ID) |
| Work/Rest Period sensor | Adjust for circadian |
| Ambient light sensor or timer (e.g., light | Night light |
| sensor 1220) | |
| Decorative lighting | On, Off, Dimming |
| Idiot lights | For sense or reading reporting |
| Beacon | Proximity of mobile device |
| Buzzer | Alarm(s) |
| Semi-Passive accessory | Beam shaping by turning ring |
| Motor | To aim or change beam profile |
| Add a fan | For a “cooler” |
| Rotating polarizer | To aim or change beam polarization |
| LCD imager (e.g., LCD projector 1234) | Local projection |
| Gobo | (see below) |
| Ambient/whitepoint correction sensor | For wall or object or painting - maintain |
| | chromaticity |
| Active-to-Active combinations | (see below) |
| Acoustic Transducer (e.g., left speaker | Music reproduction: Left and right can be |
| 1226, right speaker 1227) | set or sensed by the zone ring |
| Zone ring, zone controller (e.g., ID ring | Zone ring controls color temperature, time |
| 1230, etc.) | (e.g., for circadian cycle) |
| Mood lights that are responsive to | Use in a mood-setting mode (e.g., using |
| microphone and mood detector processor | one or more mood lights 1228). The lamp |
| | adjusts colors dependent on music played, |
| | etc. |
| SNAP elements that go onto a magnet | For multi-function flexibility |
| disposed at ring (not over glare blocker) | |
| Seismic activity sensor (e.g. seismic sensor | Detect seismic activity, filter to reduce |
| 1204) and warning | false alarms, and signal warning (e.g., at |
| | one lamp or at a group of lamps) |

Any of the active accessories, singly or in combination can be deployed onto or with a compatible lamp.

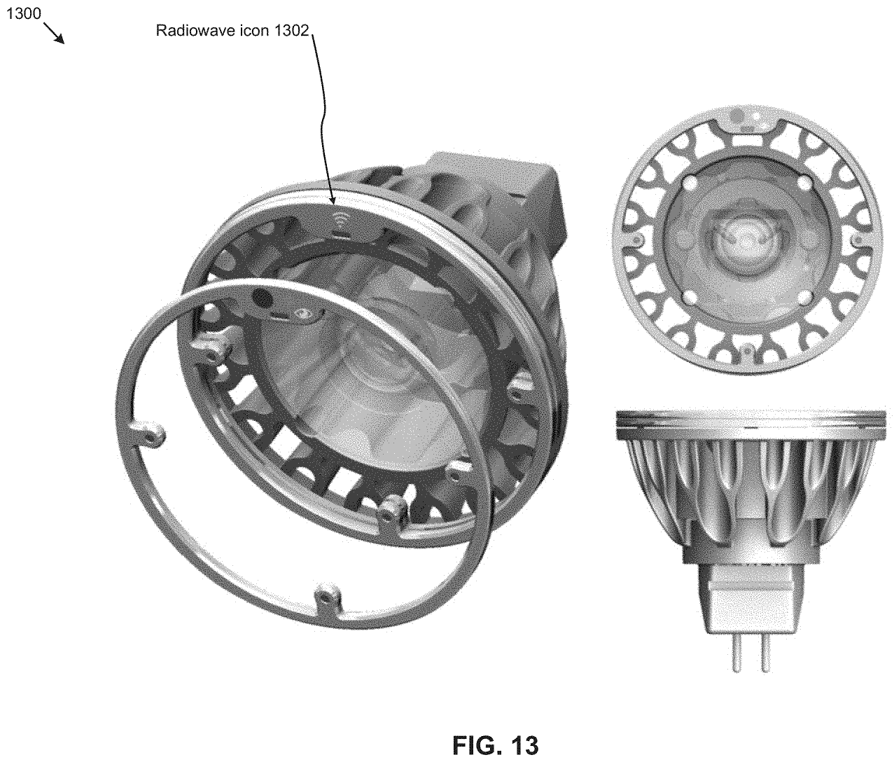

FIG. 13 depicts a selection of views 1300 of a lamp having an attachment about the periphery of the lamp face as used for hosting active accessories.

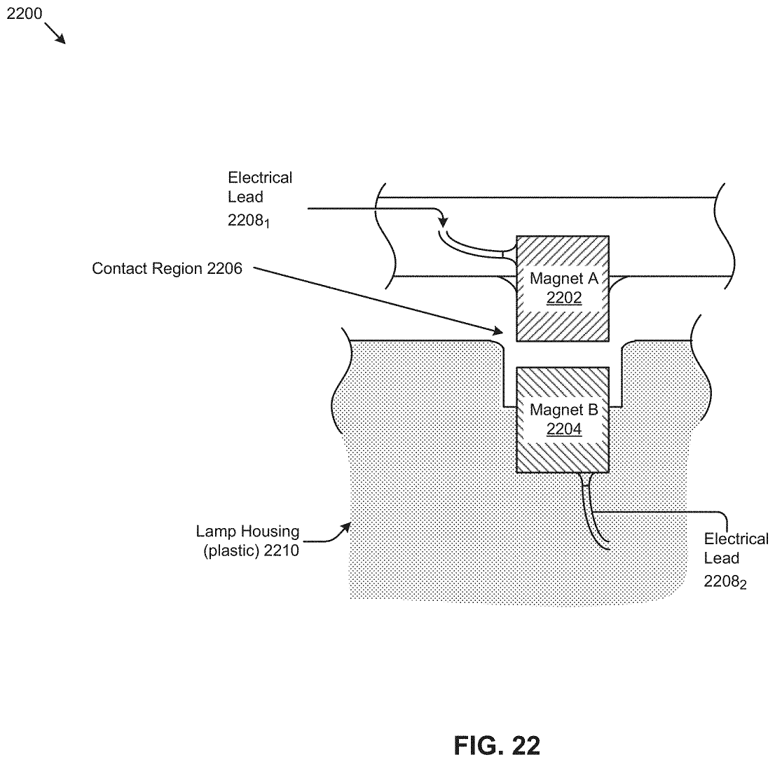

As shown in FIG. 13, the views depict an MR-16 lamp comprising a lens having a periphery with border magnets embedded about a periphery of the lens. A particular periphery can be the outermost periphery of the lamp, or can be an inner periphery, and can be placed (as shown) abutting a border. The shown border about an inner core. A first set of border magnets with a particular polarity can be embedded about a periphery of the lens, for example within the recess of a contact region. A second set of border magnets with a particular polarity can be embedded about a periphery of an accessory. The contact region is large enough such that a first border magnet positioned at the inner core can be in contact with a second border magnet positioned in a periphery of an accessory, and the contact between the two magnets can form an electrical connection. As shown, there are four contact regions, any or all of which can carry driving voltages, and/or signals, or both (e.g., a DC driving voltage and a voltage variation superimposed on the DC driving voltage). FIG. 22 shows a side-view cutaway to show a technique to use the magnets to form an electrical contact while simultaneously providing an attractive force to position the accessory over the lamp base or heat sink, or inner core.

As shown, an accessory is in contact with the lens periphery using border magnets. As shown, the first accessory hosts active functions, one of which is a wireless device (e.g., WiFi, Bluetooth, etc.). The accessory may include an icon (e.g., the wireless icon 1302, as shown).

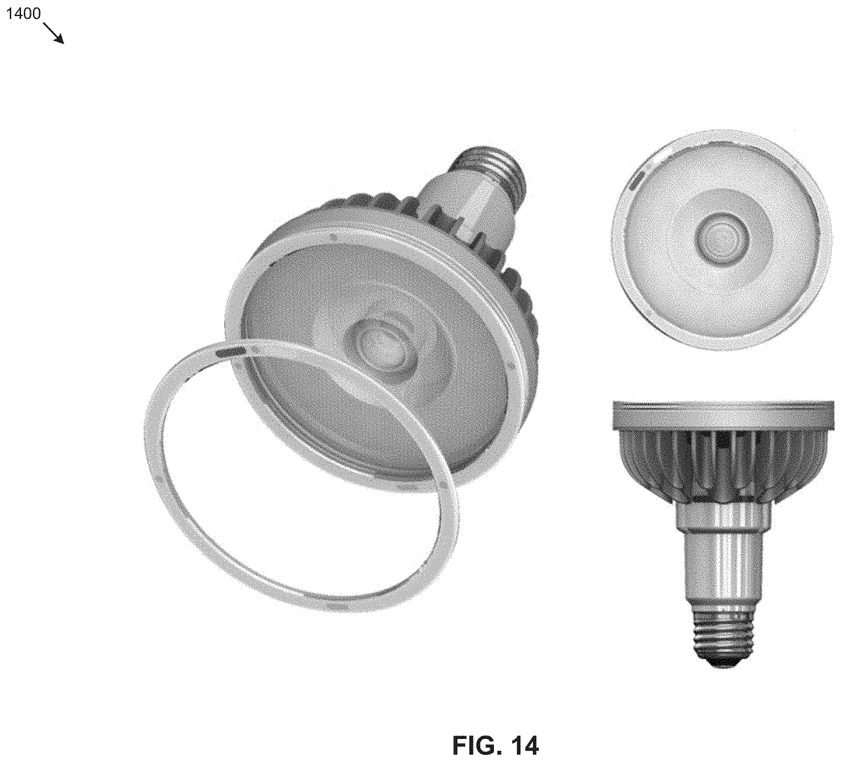

FIG. 14 depicts a selection of views 1400 of a PAR lamp having an attachment about the periphery of a PAR lamp face as used for hosting active accessories.

The views of FIG. 14 depict a PAR lamp comprising a lens having a periphery with a first magnet attached to the periphery of the lens. An accessory is in contact with the lens periphery using the magnet. As shown, the first accessory hosts active functions, one of which is a zone ID indicator.

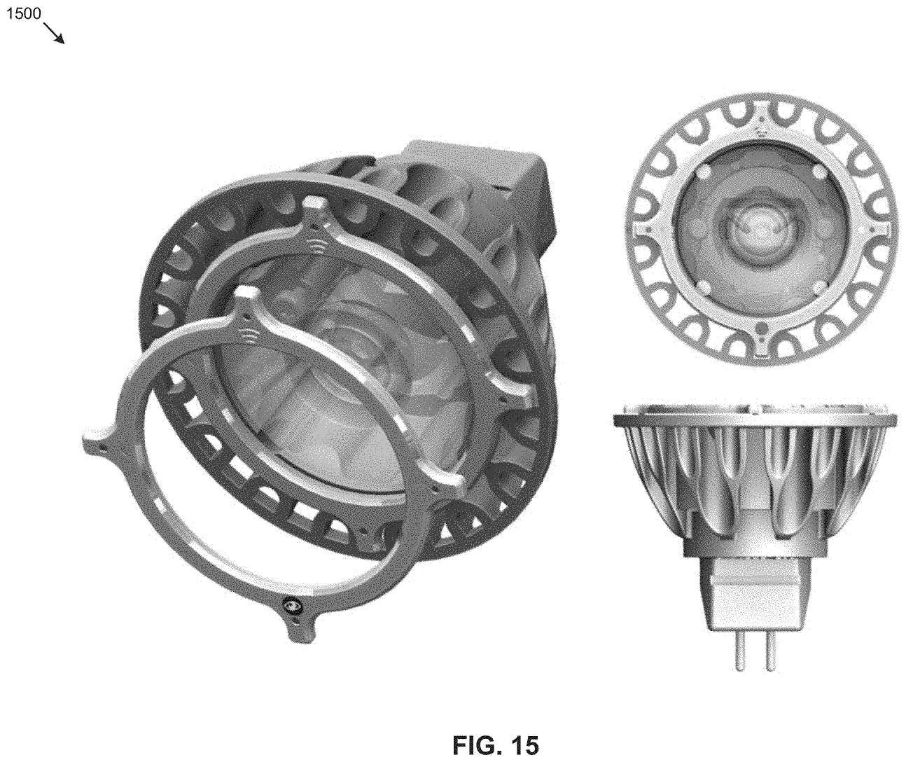

FIG. 15 depicts a selection of views 1500 of an MR-16 lamp having an auto-centering attachment positioned about the periphery of an MR-16 lamp face as used for hosting active accessories.

The views depict an MR-16 lamp comprising a lens having an inner periphery with a first magnet attached to the inner periphery of the lens. A first accessory is disposed to be in contact with the lens periphery using the magnet. As shown, the first accessory hosts active functions, one of which is a wireless device (e.g., WiFi, Bluetooth, etc.). The second accessory is disposed in contact with the first accessory. As shown, the second accessory hosts active functions, one of which is a wireless device (e.g., WiFi, Bluetooth, etc.).

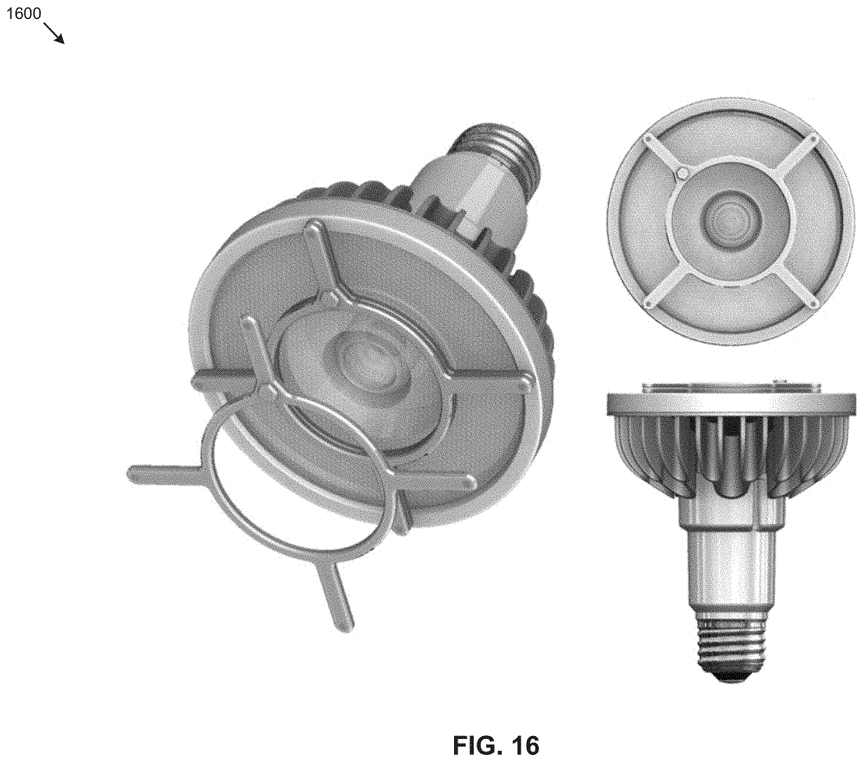

FIG. 16 depicts a selection of views 1600 of a PAR lamp having periphery attachment points positioned about the periphery of a PAR lamp face as used for hosting active accessories.

The views depict a PAR lamp comprising a lens having an inner periphery with a first magnet attached to the inner periphery of the lens. A first accessory is disposed to be in contact with the lens periphery using the magnet. As shown, the first accessory hosts active functions, one of which is a zone ID. The second accessory is disposed in contact with the first accessory. As shown, the second accessory hosts active functions, one of which is a pressure sensor.

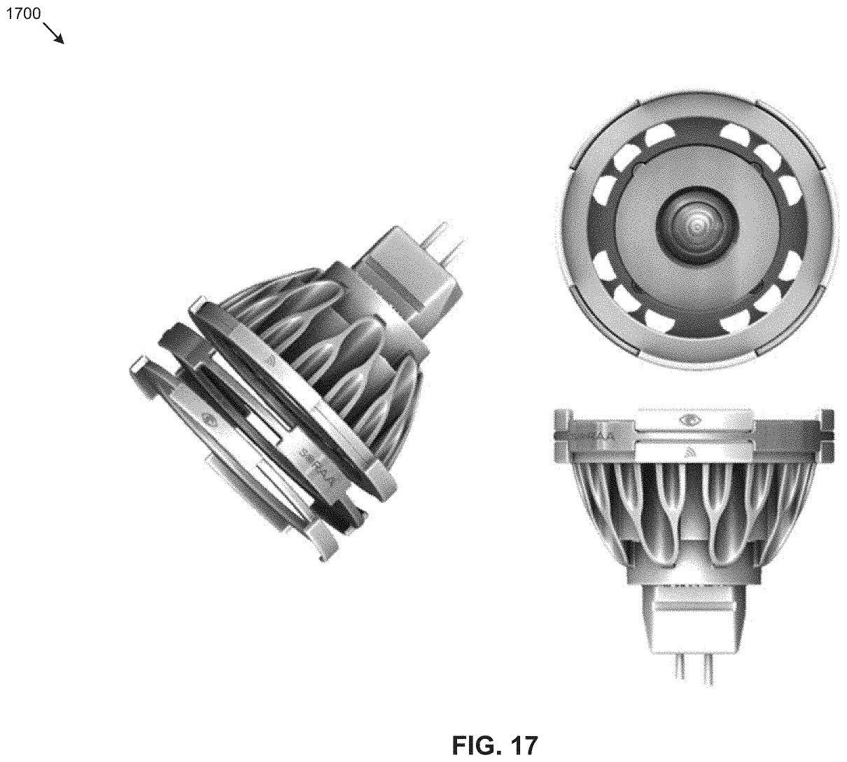

FIG. 17 depicts a selection of views 1700 of an MR-16 lamp having keyed attachment points positioned about the periphery of an MR-16 lamp face as used for hosting active accessories.

As shown, a second accessory is keyed to mate into a first accessory in pre-determined juxtaposition, and the first accessory is keyed to mate into an MR-16 lens or housing in pre-determined juxtaposition.

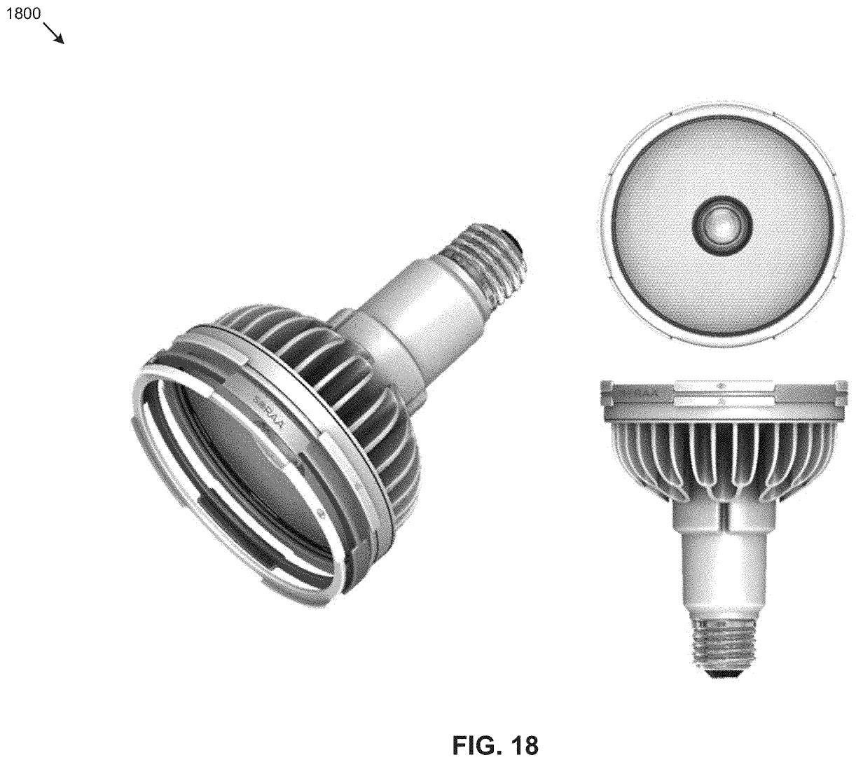

FIG. 18 depicts a selection of views 1800 of a PAR lamp having keyed attachment points positioned about the periphery of a PAR lamp face as used for hosting active accessories.

As shown, a second accessory is keyed to mate into a first accessory in pre-determined juxtaposition, and the first accessory is keyed to mate into a PAR lens or housing in pre-determined juxtaposition.

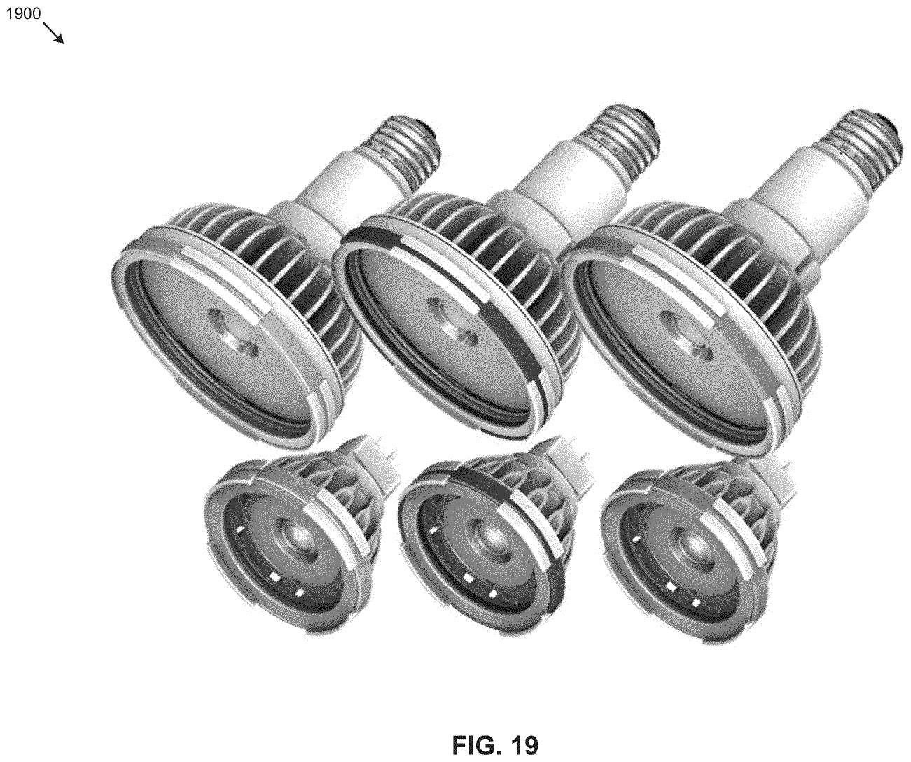

FIG. 19 depicts a selection of views 1900 of a PAR lamp having color-coded keyed attachment points positioned about the periphery of a PAR lamp face as used for hosting active accessories.

As shown, a second accessory is color-coded and is keyed to mate into a first accessory in pre-determined juxtaposition, and the first accessory is also color-coded and keyed to mate into a PAR lens or housing in pre-determined juxtaposition.

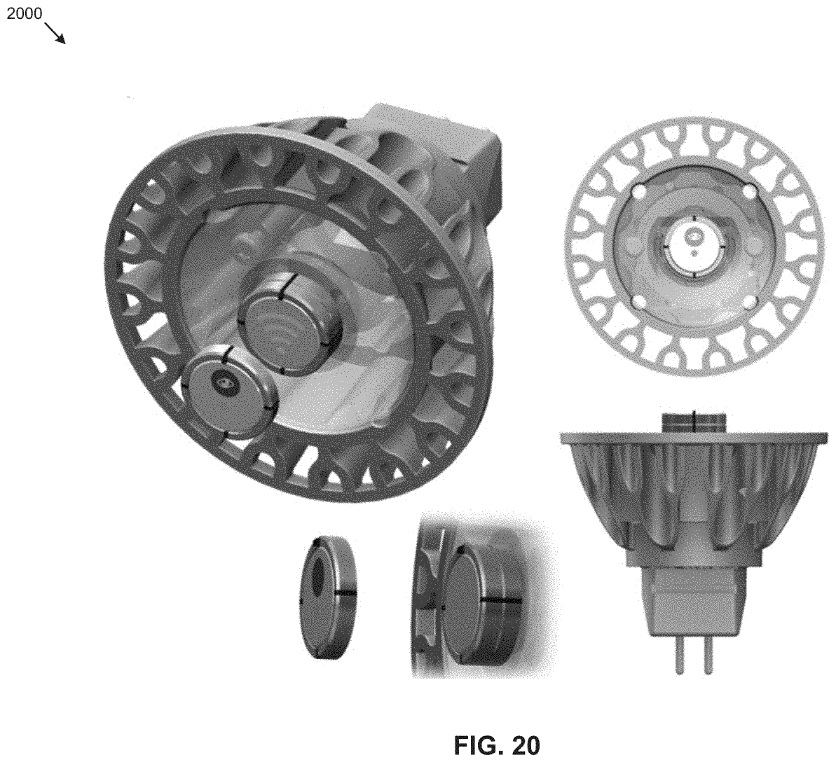

FIG. 20 depicts a selection of views 2000 of an MR-16 lamp having zone ID glare blocker for use on a lamp face as used with active accessories.

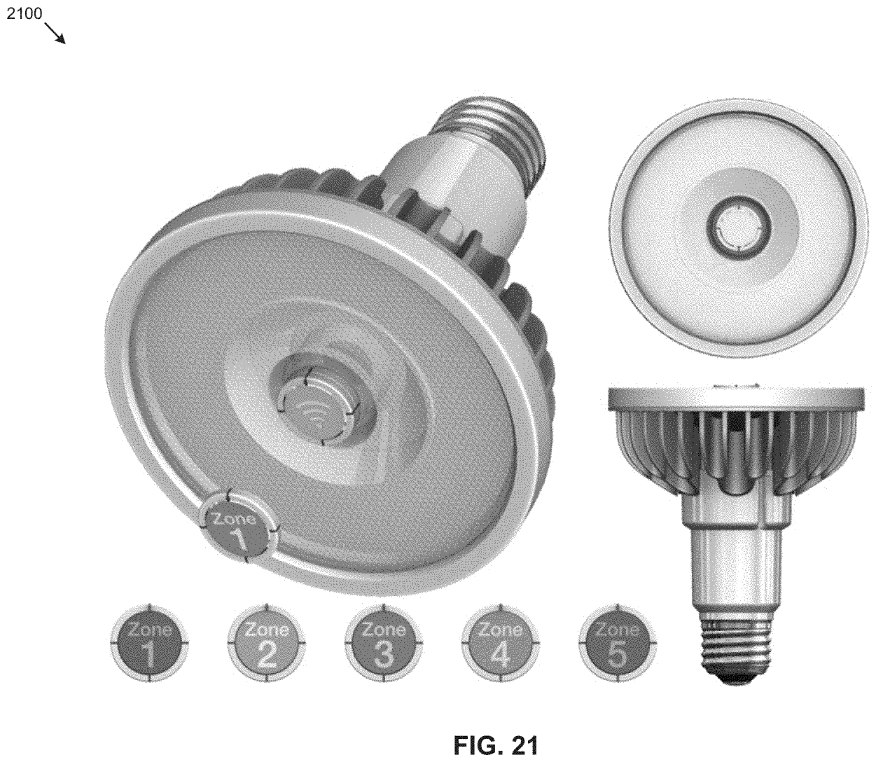

FIG. 21 depicts a selection of views 2100 of a PAR lamp having zone ID glare blockers for positioning on a lamp face as used with active accessories.

The views of FIG. 21 depict color-coded zone ID glare blockers.

Combinations of a plurality of magnets and glare blockers can be found in various embodiments. The following embodiments are presented, strictly as examples:

In certain embodiments, a light emitting diode (LED) lamp comprises: a lens having a periphery; a first magnet attached to the periphery of the lens; and a first accessory wherein the first accessory is in contact with a periphery of the lens using the magnet; and wherein the first accessory comprises at least one active function.

In certain embodiments of an LED lamp, the active function comprises a motion sensor.

In certain embodiments of an LED lamp, the active function comprises a smoke sensor.

In certain embodiments of an LED lamp, the active function comprises a gas presence sensor.

In certain embodiments of an LED lamp, the active function comprises a temperature sensor.

In certain embodiments of an LED lamp, the active function comprises a pressure sensor.

In certain embodiments of an LED lamp, the active function comprises an ambient light sensor.

In certain embodiments of an LED lamp, the active function comprises a sound sensor.

In certain embodiments of an LED lamp, the active function comprises a left speaker.

In certain embodiments of an LED lamp, the active function comprises a right speaker.

In certain embodiments of an LED lamp, the active function comprises a mood light.

In certain embodiments of an LED lamp, the lamp further comprises a second accessory having a second magnet wherein the first magnet and the second magnet are configured to retain the first accessory against the second accessory.

In certain embodiments of an LED lamp, the first magnet and the second magnet are configured to mate with the perimeter of the lens.

In certain embodiments of an LED lamp, the first accessory has a diameter that is substantially equal to a diameter of the lens.

E In certain embodiments of an LED lamp, the first accessory has a diameter that is equal to a diameter of the lens.

In certain embodiments of an LED lamp, the first accessory has a diameter that substantially covers an optical region of the lens.

In certain embodiments of an LED lamp, the lens is configured to attach to an MR16 lamp.

In certain embodiments of an LED lamp, the second accessory is selected from a diffuser, a color filter, a polarizer, a linear dispersion element, a baffle, and a combination of any of the foregoing

In certain embodiments of an LED lamp, the first magnet and the first accessory have a combined thickness less than 1 mm.

In certain embodiments of an LED lamp, the lens comprises a folded total internal reflection lens.

In certain embodiments of an LED lamp, the lamp is characterized by a lamp output mechanical aperture; and the lens is configured to cover more than 90% of the lamp output mechanical aperture.

In certain embodiments of an LED lamp, the LED lamp of embodiment 1, further comprising a second accessory having a magnet disposed about a center of the second accessory.

In certain embodiments of an LED lamp, second accessory comprises a third magnet, wherein the third magnet is attached to the center of the second accessory.

In certain embodiments, an apparatus for providing active accessories in a light emitting diode (LED) lamp, comprises: an LED illumination product having a lens and a housing; at least one electronic component disposed within the housing; at least two electrical conductors electrically-connected to the at least one electrical component, the at least two electrical conductors disposed within a rigid member affixed to the lens; and a first accessory wherein the first accessory is in contact with the lens using a magnet and wherein the first accessory comprises at least one active function.

In certain embodiments of an apparatus, the rigid member accepts a USB connector.

In certain embodiments of an apparatus, the rigid member is made of a magnetic material.

In certain embodiments of an apparatus, the rigid member is affixed to the lens with an adhesive.

In certain embodiments of an apparatus, the rigid member is affixed to a periphery of the lens using a mechanical connector.

In certain embodiments of an apparatus, the rigid member is affixed to a center of the lens using a mechanical connector.

In certain embodiments, a light emitting diode (LED) lamp comprises: a lens having a periphery; a first magnet attached to the periphery of the lens; a first accessory wherein the first accessory is in contact with a periphery of the lens using the magnet; and wherein the first accessory comprises at least one first active function; and a second accessory wherein the second accessory is in contact with the first accessory and wherein the second accessory comprises at least one second active function.

In certain embodiments of an LED lamp, the first active function comprises a zone ID and the second active function comprises a wireless device.

In certain embodiments of an apparatus, the first active function comprises a color-coded zone ID and the second active function comprises a wireless device.

In certain embodiments of an apparatus, the first active function comprises a zone ID and the second active function comprises a Bluetooth wireless device.

In certain embodiments of an apparatus, the first active function comprises a zone ID and the second active function comprises a WiFi wireless device.

In certain embodiments of an apparatus, the first active function comprises a zone ID and the second active function comprises a smoke sensor.

In certain embodiments of an apparatus, the first active function comprises a zone ID and the second active function comprises an ambient light sensor.

In certain embodiments of an apparatus, the first active function comprises a zone ID and the second active function comprises a seismic sensor.

In certain embodiments of an apparatus, the first active function comprises a zone ID and the second active function comprises a gas presence sensor.

In certain embodiments of an apparatus, the first active function comprises a zone ID and the second active function comprises a wireless device.

In certain embodiments of an apparatus, the first active function comprises a zone ID and the second active function comprises a pressure sensor.

FIG. 22 depicts a side side-view cutaway to show use of two or more magnets to form an electrical contact. As shown, a first border magnet (e.g., magnet B 2204) is embedded in a lamp housing 2210. A second border magnet (e.g., magnet A 2202) is embedded in an accessory. A first electrical lead 22081 carries current, and a second electrical lead 22022 also carries a current. When first border magnet is in contact with second border magnet (e.g. at the point shown as contact region 2206) current can be carries through first border magnet to second border magnet and through electrical leads, and the current can be used to provide power to an active accessory.

Finally, it should be noted that there are alternative ways of implementing the embodiments disclosed herein. Accordingly, the present embodiments are to be considered as illustrative and not restrictive, and the claims are not to be limited to the details given herein, but may be modified within the scope and equivalents thereof.

1. (canceled)

2. A system of lights, comprising:
two or more zones of one or more lights, each zone comprising at least one light, wherein said one or more lights of each of said zones function together to output light; and
at least one electronic accessory connected to said at least one light of each zone, said electronic accessory configured for providing functionality to said zone, said functionality comprising at least a first functionality to impart a zone designation in said at least one light.

3. The system of claim 2, wherein said at least one light is configured to remember said zone designation if said electronic accessory is disconnected from said at least one light.

4. The system of claim 2, wherein said at least one light of one zone of said two or more zones is also grouped with another zone of said two or more zones.

5. The system of claim 2, wherein said functionality comprises a second functionality to facilitate communication among two or more lights in one of said two or more zones.

6. The system of claim 2, wherein said functionality comprises a second functionality to facilitate communication between said at least one light of a zone and at least one of a controlling/monitoring device or the Internet.

7. The system of claim 6, wherein said second functionality is wireless.

8. The system of claim 6, wherein said second functionality wirelessly connects said zone to said Internet via a cloud-based control/monitor.

9. The system of claim 1, wherein said at least one electronic accessory is connected to each light in a zone of said two or more zones.

10. The system of claim 1, wherein said at least one electronic accessory is removably connectable to said at least one light.

11. The system of claim 1, wherein said at least one electronic accessory is permanently affixed to said at least one light.

12. The system of claim 1, wherein said functionality comprises at least one sensor to sense at least one of ambient light, motion, occupancy, temperature, IR data, proximity, gasses, products of combustion, smoke, humidity, human body temperature, or remote object temperature

13. The system of claim 12, wherein said at least one light is disposed closest to an entrance of a room, and said at least one electronic accessory has a motion sensor.

14. The system of claim 12, wherein said electronic accessory has an ambient light sensor.

15. The system of claim 14, wherein said at least one light is closest to an exterior window.

16. A method of controlling a system of lights, said system of lights comprising two or more zones of one or more lights, each zone comprising at least one light, wherein said one or more lights of each of said zones function together to output light, and at least one electronic accessory connectable to said at least one light of each zone, said electronic accessory configured for providing functionality to said zone, said functionality comprising at least a first functionality to impart a zone designation in said at least one light, said method comprising:
activating said at least one electronic accessory to impart said at least one light with said zone identification.

17. The method of claim 16, wherein said activating comprises connecting said at least one electronic accessory to said at least one light.

18. The method of claim 16, wherein one of said one or more lights of one zone of said zones comprises an electronic accessory having a motion sensor, and causes said other lights of said one zone to output light when motion is detected.

19. The method of claim 16, wherein one of said one or more lights of one zone of said zones comprises an ambient light sensor, and causes said other lights of said one zone to alter light output based on said ambient light detected.

20. The method of claim 16, further comprising causing said one or more lights of a zone to at least output maximum light or indicate egress upon an event trigger.

21. The method of claim 16, wherein said functionality comprises assigning an email address for said at least one light or for each zone comprising said at least one light.
